(19) United States
(12) Patent Application Publication
(10) Pub. No.: US 2018/0136378 A1
(43) Pub. Date: May 17, 2018

(54) Display Panel and WRGB Pixel Structure

(71) Applicant: Shenzhen China Star Optoelectronics Technology Co., Ltd., Shenzhen, Guangdong (CN)

(72) Inventor: Zhixiong JIANG, Shenzhen, Guangdong (CN)

(73) Assignee: Shenzhen China Star Optoelectronics Technology Co., Ltd., Shenzhen, Guangdong (CN)

(21) Appl. No.: 15/125,156

(22) PCT Filed: Jun. 8, 2016
(86) PCT No.: PCT/CN2016/085359

§ 371 Date: Sep. 10, 2016

(30) Foreign Application Priority Data
May 24, 2016 (CN) 201610350091.0

(51) Int. Cl. G02B 5/20

(52) U.S. Cl. CPC G02B 5/201

(57) ABSTRACT

The present disclosure proposes a WRGB pixel structure, including pixel units in an array. Each pixel unit includes a red sub-pixel, green sub-pixel, blue sub-pixel, and white sub-pixel. An area to form the white sub-pixel is on at least one of the red sub-pixel, green sub-pixel, and blue sub-pixel. Through adding a white sub-pixel into each pixel unit, and disposing the white sub-pixel in one area of at least one of the red sub-pixel, green sub-pixel and blue sub-pixel, the present invention introduces the W sub-pixel to the original RGB sub-pixels. It elevates the transmittance of the display panel, and lowers energy consumption and cost while ensuring that the resolution of the display panel is not affected. It also guarantees a good compatibility of the pixel structure which only requires an ordinary RGB pixel driving chip to deliver the effect of a WRGB display.

### BACKGROUND OF THE INVENTION

### 1. Field of the Invention

The present invention relates to the field of display technology, and especially to a display panel and WRGB pixel structure.

### 2. The Related Arts

Traditional pixels are composed of red (R), green (G), and blue (B) sub-pixels. A full high definition (FHD) panel has 1920×1080 pixels, with each pixel composed of three sub-pixels. Therefore, the FHD panel has around 6.2 million different colors. On the other hand, an ultra high definition (UHD) panel has 3840×2160 pixels, meaning that it has around 24.9 million colors. Therefore, the resolution of a UHD panel is four times of that of a FHD panel.

As shown in FIG. 1, a RGBW 4K panel is slightly different from a traditional UHD panel in the way that a white (W) sub-pixel is added to RGB sub-pixels. Simply put, with a UHD panel, the number of pixels on each horizontal scan line is 3840, and its RGB structure is composed of 11520 sub-pixels. On the other hand, with the structure of a RGBW panel, in which a pixel is composed of 4 sub-pixels, the actual number of pixels on each horizontal scan line is down to 2880. However, the number of pixels on vertical lines is still 2160, the same as an UHD panel with a RGB structure.

In fact, the idea of adding a W sub-pixel is not being used on TV panels for the first time. The design concept of RGBW sub-pixels has been applied to mobile phone panels, such as PenTile of Samsung or WhiteMagic of Sony. Although the RGBW structure adopted by UHD panels can lower the cost, it might also affect the image quality. The reason is that adding W sub-pixels crowds out pixels of the original RGB structure.

However, RGBW panel saves the cost to a sizable extent. Generally speaking, a back-lit module is the part that accounts for the largest share of the cost of a TV panel. The share grows higher as the panel size goes larger. When the resolution of the TV panel upgrades from FHD to UHD, the number of pixels grows four times of the original, leading to tremendous decrease in transmittance. If operating based on traditional RGB technology, the UHD panel's transmittance is only 60% of the FHD panel. Therefore, the UHD panel needs more LED to maintain the same degree of lightness, thus increases the cost.

### SUMMARY OF THE INVENTION

One object of the present invention is to provide a display panel and a WRGB pixel structure to address the insufficiency of the current technology. The present invention provides higher transmittance without compromising the panel's resolution, and lowers energy consumption and the cost of the back-lit module.

Through adding a white sub-pixel into each pixel unit, and disposing the white sub-pixel in one area of at least one of the red sub-pixel, green sub-pixel and blue sub-pixel, the present invention introduces the W sub-pixel to the original RGB sub-pixels. It elevates the transmittance of the display panel, and lowers energy consumption and cost while ensuring that the resolution of the display panel is not affected. It also guarantees a good compatibility of the pixel structure which only requires an ordinary RGB pixel driving chip to deliver the effect of a WRGB display.

### BRIEF DESCRIPTION OF THE DRAWINGS

FIG. 1 shows an arrangement of pixels of a conventional 4K panel.

FIG. 2a shows a first arrangement of pixels of a display panel according to a first embodiment of the present embodiment.

FIG. 2b shows a second arrangement of pixels of a display panel according to a first embodiment of the present embodiment.

FIG. 2c shows a third arrangement of pixels of a display panel according to a first embodiment of the present embodiment.

FIG. 3a shows a first arrangement of pixels of a display panel according to a second embodiment of the present embodiment.

FIG. 3b shows a second arrangement of pixels of a display panel according to a second embodiment of the present embodiment.

FIG. 3c shows a third arrangement of pixels of a display panel according to a second embodiment of the present embodiment.

FIG. 4a shows a first arrangement of pixels of a display panel according to a third embodiment of the present embodiment.

FIG. 4b shows a second arrangement of pixels of a display panel according to a third embodiment of the present embodiment.

FIG. 5a shows a first arrangement of pixels of a display panel according to a fourth embodiment of the present embodiment.

FIG. 5b shows a second arrangement of pixels of a display panel according to a fourth embodiment of the present embodiment.

### DETAILED DESCRIPTION OF THE PREFERRED EMBODIMENTS

Embodiments of the present invention are described in detail with the technical matters, structural features, achieved objects, and effects with reference to the accompanying drawings as follows. Specifically, the terminologies in the embodiments of the present invention are merely for describing the purpose of the certain embodiment, but not to limit the invention.

A display panel of the present invention comprises a WRGB pixel structure comprising crisscrossing data lines and gate lines. Each WRGB pixel structure comprises a plurality of pixel units arranged in arrays. Each pixel unit comprises a red sub-pixel, a green sub-pixel, a blue sub-pixel and a white sub-pixel. An area to form the white sub-pixel is disposed on at least one of the red sub-pixel, green sub-pixel and blue sub-pixel in each pixel unit.

An independent white sub-pixel is introduced to design the WRGB display panel. The area where the white sub-pixel is disposed is arranged in corresponding areas of the red sub-pixel, green sub-pixel and blue sub-pixel. Therefore, the original RGB pixels are not crowded out because of the added W sub-pixels. It ensures the resolution of the display panel. And it has good compatibility, requiring only an ordinary RGB pixel driving chip to deliver a WRGB display effect. The location and size of the area where the white sub-pixel is disposed can be arranged freely in accordance with different requirements, so to meet different display needs.

### Embodiment 1

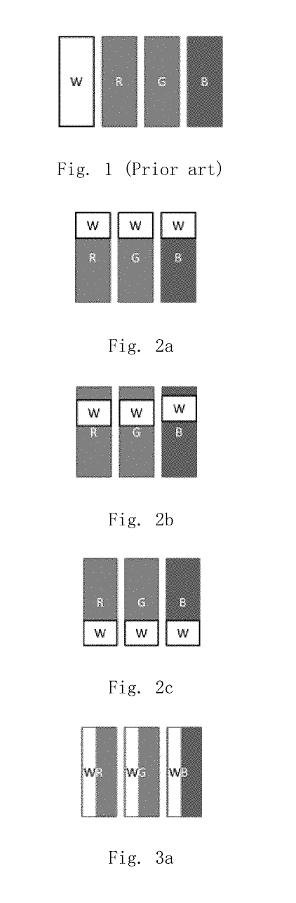

Please refer to FIGS. 2a to 2c. A red sub-pixel R, green sub-pixel G and blue sub-pixel B of each pixel unit are arranged in a horizontal line. An area to form a white sub-pixel W is disposed on each red sub-pixel R, green sub-pixel G and blue sub-pixel B. The white sub-pixel W is disposed in corresponding areas lined vertically on the sub-pixels.

FIG. 2a is one implementation of the present embodiment. The area to form the white sub-pixel W is located on the top of each red sub-pixel R, green sub-pixel G and blue sub-pixel B.

FIG. 2b is another implementation of the present embodiment. The area to form the white sub-pixel W is located in the middle of each red sub-pixel R, green sub-pixel G and blue sub-pixel B. With such arrangement, each sub-pixel is divided into three areas-top, middle and bottom.

FIG. 2c is another implementation of the present embodiment. The area to form the white sub-pixel W is located on the bottom of each red sub-pixel R, green sub-pixel G and blue sub-pixel B.

### Embodiment 2

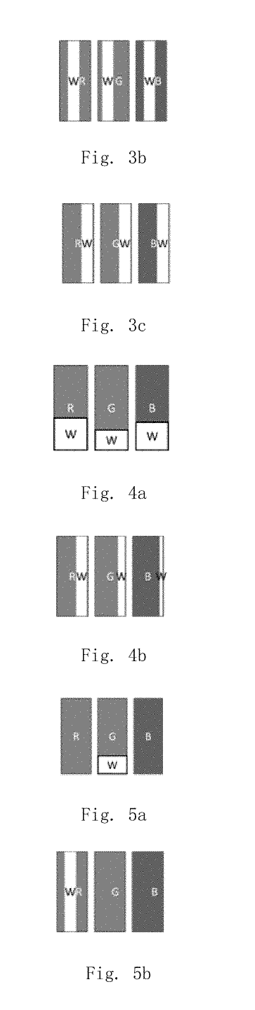

Please refer to FIGS. 3a to 3c.The area to form a white sub-pixel W on each red sub-pixel R, green sub-pixel G and blue sub-pixel B can be disposed in corresponding areas lined horizontally on the sub-pixels.

FIG. 3a shows that the area to form the white sub-pixel W on each red sub-pixel R, green sub-pixel G and blue sub-pixel B is disposed on the left side area of each sub-pixel.

FIG. 3b shows that the area to form the white sub-pixel W on each red sub-pixel R, green sub-pixel G and blue sub-pixel B is disposed in the middle of each sub-pixel. Each sub-pixel is thus divided into a left side area, middle area and right side area.

FIG. 3c shows that the area to form the white sub-pixel W on each red sub-pixel R, green sub-pixel G and blue sub-pixel B is disposed on the right side area of each sub-pixel.

### Embodiment 3

Please refer to FIGS. 4a and 4b. The sizes of the area to form a white sub-pixel W on the red sub-pixel R, green sub-pixel G and blue sub-pixel B are disposed differently according to display needs. FIG. 4a shows one scenario when the white sub-pixel W is disposed vertically in the corresponding areas on each corresponding pixels. FIG. 4b shows another scenario when the white sub-pixel W is disposed horizontally in the corresponding areas on each corresponding pixels.

### Embodiment 4

Please refer to FIGS. 5a and 5b, which are exceptions of Embodiment 3. The white sub-pixel W only exists in one of the red sub-pixel R, green sub-pixel G and blue sub-pixel B. FIG. 5a shows a scenario when the white sub-pixel W is only disposed vertically on the green sub-pixel G. FIG. 5b shows another scenario when the white sub-pixel W is only disposed horizontally on the red sub-pixel R.

Understandably, in each pixel unit, the red sub-pixel R, green sub-pixel G, blue sub-pixel B and white sub-pixel W can be arranged differently. The position of the white sub-pixel W in each sub-pixel in each pixel unit can be different too. For example, the white sub-pixel W can be disposed on the top area of the red sub-pixel R, the middle area of the green sub-pixel G, and the bottom area of the blue sub-pixel B. It can also be disposed on the left side area of the red sub-pixel R, the middle area of the green sub-pixel G, and the right side area of the blue sub-pixel B. The position of the white sub-pixel is not limited to those referred to in the abovementioned implementation scenarios.

Through adding a white sub-pixel into each pixel unit, and disposing the white sub-pixel in one area of at least one of the red sub-pixel, green sub-pixel and blue sub-pixel, the present invention introduces the W sub-pixel to the original RGB sub-pixels. It elevates the transmittance of the display panel, and lowers energy consumption and cost while ensuring that the resolution of the display panel is not affected. It also guarantees a good compatibility of the pixel structure which only requires an ordinary RGB pixel driving chip to deliver the effect of a WRGB display.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A WRGB pixel structure, comprising a plurality of pixel units arranged in an array, with each pixel unit comprising a red sub-pixel, green sub-pixel, and blue sub-pixel, wherein each pixel unit further comprises a white sub-pixel, and an area to form the white sub-pixel on at least one of the red sub-pixel, green sub-pixel, and blue sub-pixel.

2. The WRGB pixel structure of claim 1, wherein an area to form the white sub-pixel is disposed on each of the red sub-pixel, green sub-pixel, and blue sub-pixel.

3. The WRGB pixel structure of claim 2, wherein areas to form the white sub-pixel on each of the red sub-pixel, green sub-pixel, and blue sub-pixel are of difference sizes.

4. The WRGB pixel structure of claim 2, wherein areas to form the white sub-pixel on each of the red sub-pixel, green sub-pixel, and blue sub-pixel are located on a top side of each sub-pixel.

5. The WRGB pixel structure of claim 4, wherein areas to form the white sub-pixel on each of the red sub-pixel, green sub-pixel, and blue sub-pixel are of difference sizes.

6. The WRGB pixel structure of claim 2, wherein areas to form the white sub-pixel on each of the red sub-pixel, green sub-pixel, and blue sub-pixel are located in the middle of each sub-pixels, dividing each sub-pixels into the top, middle, and bottom areas.

7. The WRGB pixel structure of claim 6, wherein areas to form the white sub-pixel on each of the red sub-pixel, green sub-pixel, and blue sub-pixel are of difference sizes.

8. The WRGB pixel structure of claim 2, wherein areas to form the white sub-pixel on each of the red sub-pixel, green sub-pixel, and blue sub-pixel are located on a bottom side of each sub-pixel.

9. The WRGB pixel structure of claim 8, wherein areas to form the white sub-pixel on each of the red sub-pixel, green sub-pixel, and blue sub-pixel are of difference sizes.

10. The WRGB pixel structure of claim 2, wherein areas to form the white sub-pixel on each of the red sub-pixel, green sub-pixel, and blue sub-pixel are located on a left side of each sub-pixel.

11. The WRGB pixel structure of claim 10, wherein areas to form the white sub-pixel on each of the red sub-pixel, green sub-pixel, and blue sub-pixel are of difference sizes.

12. The WRGB pixel structure of claim 2, wherein areas to form the white sub-pixel on each of the red sub-pixel, green sub-pixel, and blue sub-pixel are located in the middle of each sub-pixels, dividing each sub-pixels into the left side, middle, and right side areas.

13. The WRGB pixel structure of claim 12, wherein areas to form the white sub-pixel on each of the red sub-pixel, green sub-pixel, and blue sub-pixel are of difference sizes.

14. The WRGB pixel structure of claim 2, wherein areas to form the white sub-pixel on each of the red sub-pixel, green sub-pixel, and blue sub-pixel are located on a right side of each sub-pixel.

15. The WRGB pixel structure of claim 14, wherein areas to form the white sub-pixel on each of the red sub-pixel, green sub-pixel, and blue sub-pixel are of difference sizes.

16. A display panel comprising the WRGB pixel structure as claimed in claim 1.

17. The display panel of claim 16, wherein an area to form the white sub-pixel is disposed on each of the red sub-pixel, green sub-pixel, and blue sub-pixel.

18. The display panel of claim 17, wherein areas to form the white sub-pixel on each of the red sub-pixel, green sub-pixel, and blue sub-pixel are of difference sizes.

19. The display panel of claim 17, wherein an area to form the white sub-pixel is disposed on each of the red sub-pixel, green sub-pixel, and blue sub-pixel.

20. The display panel of claim 19, wherein areas to form the white sub-pixel on each of the red sub-pixel, green sub-pixel, and blue sub-pixel are of difference sizes.
